(19) United States
(12) Patent Application Publication
(10) Pub. No.: US 2018/0047289 A1
(43) Pub. Date: Feb. 15, 2018

(54) RELEASE CONTROL OF A PARKING SPACE

(71) Applicant: Robert Bosch GmbH, Stuttgart (DE)

(72) Inventors: Gerrit Quast, Nuertingen (DE); Stefan Nordbruch, Kornwestheim (DE)

(21) Appl. No.: 15/557,174

(22) PCT Filed: Jan. 28, 2016
(86) PCT No.: PCT/EP2016/051751

§ 371 Date: Sep. 11, 2017

(30) Foreign Application Priority Data
Mar. 11, 2015 (DE) 10 2015 204 366.5

(51) Int. Cl. G08G 1/14; G08G 1/04

(52) U.S. Cl. CPC G08G 1/146; G08G 1/04

(57) ABSTRACT

A system for release control of a parking space for a motor vehicle includes an electrical charging device, mounted in the region of the parking space, for a motor vehicle having an electrical drive energy reservoir; a sensor for determining whether a motor vehicle is present in the parking space; a device for determining whether the charging system is in operation; and a processing device for releasing the parking space for use by a motor vehicle having an electrical drive energy reservoir if and conditional upon that the charging system is not connected to a motor vehicle and a motor vehicle is not present in the parking space.

### CROSS-REFERENCE TO RELATED APPLICATIONS

The present application is the national stage of International Pat. App. No. PCT/EP2016/051751 filed Jan. 28, 2016, and claims priority under 35 U.S.C. § 119 to DE 10 2015 204 366.5, filed in the Federal Republic of Germany on Mar. 11, 2015, the content of each of which are incorporated herein by reference in their entireties.

### FIELD OF THE INVENTION

The present invention relates to a release control system for a parking space. The invention relates in particular to recognition of the occupancy of a parking space for a motor vehicle.

### BACKGROUND

A parking area is provided as a parking space for a motor vehicle. The motor vehicle can encompass, in particular, a passenger car. A corresponding authorization is required in order to be able to use the parking space. This authorization can be obtained by way of a reservation system. A parking space can be associated with a specific motor vehicle, or the parking space can be rented or reserved for a predetermined time period.

The motor vehicle can be electrically propelled, for which purpose it encompasses an electrical drive energy reservoir. An electrical charging device can be provided in the region of the parking space in order to charge the energy reservoir. The availability of a parking space having a usable electrical charging device can be important for operation of the motor vehicle. Often a plurality of parking spaces are kept on hand for motor vehicles, only a portion of them being equipped with electrical charging devices. It is possible in this context for a motor vehicle not having an electrical drive energy reservoir to be parked in a parking space having an electrical charging device. A motor vehicle having a drive energy reservoir can also be parked in a parking space equipped with an electrical charging device even though the charging device is not used. In both cases, the charging device can no longer be available for a motor vehicle that requires charging.

A reservation system for a parking space having an electrical charging device can identify the availability of the parking space based on the utilization of the charging device. If charging is not occurring or if the electrical charging device is not connected to a motor vehicle, the parking space can be categorized as occupyable.

### SUMMARY

The improper occupancy described above, however, is usually not recognized. An object of the present invention is therefore to furnish an improved system, an improved method, and an improved computer program product for release control of a parking space having an electrical charging device.

According to an example embodiment of the present invention, a system for release control of a parking space for a motor vehicle includes: an electrical charging device, mounted in the region of the parking space, for a motor vehicle having an electrical drive energy reservoir; a device for determining whether the charging system is in operation; and a processing device for releasing the parking space for use by a motor vehicle having an electrical drive energy reservoir if the charging system is not connected to a motor vehicle. In addition, a sensor is provided for determining whether a motor vehicle is present in the parking space, and the processing device is configured to release the parking space only if a motor vehicle is also not present in the parking space.

It is thereby possible, for example, to prevent a reservation system for the parking space from categorizing the latter as assignable to a motor vehicle having an electrical energy reservoir if a motor vehicle is present in the parking space even though it is not connected to the electrical charging device. A motor vehicle that requires charging can thereby be directed in improved fashion to a parking space which is not occupied by a motor vehicle and whose charging device is available for use. Utilization of the charging device can additionally be improved. The parking space, or an assemblage of many parking spaces at least some of which are equipped with electrical charging devices, can thereby be operated more profitably.

In an embodiment, for example, the sensor can be mounted in a region below or above the motor vehicle and connected to the processing device. In a further embodiment the sensor is embodied in integrated fashion with the charging device. For example, the charging device can encompass a charging pedestal on which a connecting cable for the motor vehicle is furnished. The sensor can be integrated into the charging pedestal, so that no additional is necessary in order to mount the sensor physically in the region of the parking space. Connections for energy supply and data transmission for the sensor can furthermore be kept short and can be easily laid out.

In a further embodiment the sensor is provided outside the charging device. As a result, the sensor can more easily be configured to monitor several parking spaces.

The sensor can encompass, for example, a light barrier, an ultrasonic sensor, a radar sensor, a lidar sensor, or a laser sensor. In a further embodiment the sensor can encompass an optical camera in order to determine the presence of the motor vehicle in the parking space. The optical sensor can also optionally supply additional information, for example automatic recognition of a license plate of the motor vehicle or illumination of the motor vehicle during optical imaging. A video camera can also be used, so that moving images of the motor vehicle can be acquired. Several sensors can also be used, so that the presence of the motor vehicle can be determined with improved resolution or reliability.

It is particularly preferred that the sensor be mounted above the motor vehicle. In a parking structure or underground garage the sensor can, as a result, be mounted in space-saving fashion and with little outlay. The sensor's recognition performance can be high.

The sensor can encompass a camera, the processing device being configured to store a camera image or a camera video if a motor vehicle is present in the parking space. The stored image can thus serve documentation purposes. In particular, on the basis of the image it is possible to determine whether a valid authorization existed for the parked vehicle at the time of imaging.

The processing device is preferably configured to forward the occupancy level of the parking space to a reservation system for the parking space. The occupancy level can also encompass, in addition to “vacant” and “occupied,” the status “occupied with no charging operation.” Further supported occupancy levels can encompass, for example, “reserved,” “reserved with charging,” and “reserved without charging.” A reservation system for the parking space can thereby better process an incoming reservation request. In an embodiment, additional information is also transmitted together with the occupancy level, for example a camera image or a video sequence of the parking space or an identification of the motor vehicle, which can have been generated, for example, from a camera image or video image by automatic license plate recognition.

According to an example embodiment, a method for release control of a parking space for a motor vehicle includes: determining that an electrical charging device available at the parking space is not connected to a motor vehicle; and releasing the parking space for utilization by a motor vehicle having an electrical drive energy reservoir, the release occurring only if an additional determination is made that a motor vehicle is not present in the parking space.

The method can additionally encompass steps of: scanning an identification of the motor vehicle present in the parking space; comparing the identification with an identification of a motor vehicle for which a valid reservation for using the parking space has been issued; and outputting a warning if the identifications do not match.

The sensors available in the region of the parking space can be used in order to determine improper occupancy of the parking space. A warning can be outputted in various configurations in the region of the parking space, and can be directed to a driver of the motor vehicle parking without authorization or can be forwarded to another system, in particular a reservation system for the parking space. The reservation system can then initiate appropriate steps to resolve the improper occupancy. These can include, for example, legal measures, towing of the motor vehicle, or increasing a parking space fee.

The warning can encompass the identification of the motor vehicle present in the parking space. This identification can be useful in particular in the context of the initiation of legal measures against a driver or owner of the illegally parked motor vehicle. The identification can encompass, for example, a camera image, a video sequence, or a recognized license plate of the motor vehicle.

According to an example embodiment, a computer program product encompasses program code means for carrying out the above-described method when the computer program product executes on a processing device or is stored on a computer-readable data medium. In particular, the computer program product can be executed on the processing device of the above-described system.

The invention will now be explained in more detail below with reference to the appended Figures.

### BRIEF DESCRIPTION OF THE DRAWINGS

FIG. 1 depicts a reservation system for a parking space according to an example embodiment of the present invention.

FIGS. 2A-2D depict occupancy sensors for a parking space according to various example embodiments of the present invention.

### DETAILED DESCRIPTION

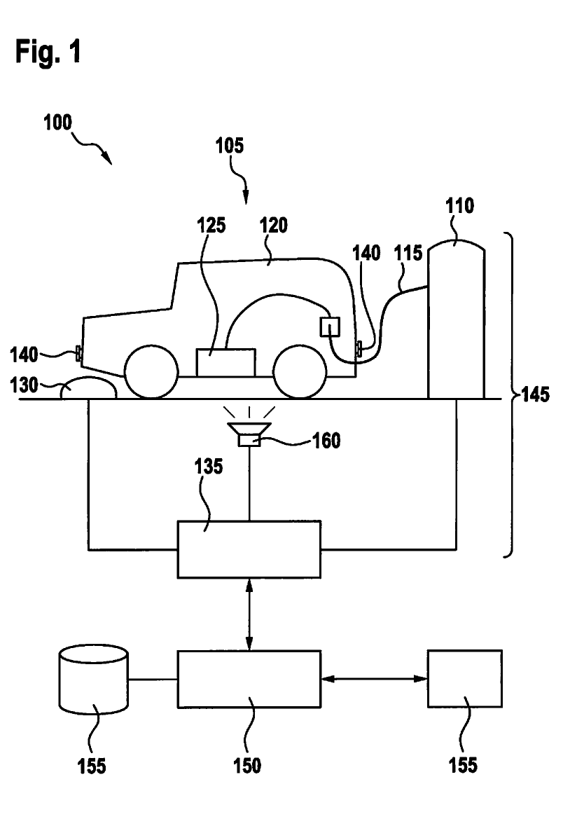

FIG. 1 shows a reservation system 100 for a parking space 105. An electrical charging device 110 is provided at parking space 105. Charging device 110 can encompass a connecting cable 115 in order to connect a motor vehicle 120, which encompasses an electrical drive energy reservoir 125, to charging device 110 so that it can be electrically charged. Motor vehicle 120 usually encompasses an electric motor to propel motor vehicle 120 using energy from electrical drive energy reservoir 125.

A sensor 130, which is configured to determine whether or not a motor vehicle 120 is present in parking space 105, is also mounted in the region of parking space 105. A processing device 135 is connected to charging device 110 and to sensor 130. Processing device 135 receives information from charging device 110 as to whether charging device 110 is connected to a motor vehicle 120 having an electrical energy reservoir 125. In an example embodiment, the connection can be identified if an operation of charging drive energy reservoir 125 from charging device 110 is occurring. In another embodiment, a check is made as to whether electrical connection 115 has been created between charging device 110 and motor vehicle 120. As a result, the connected state can be correctly recognized even when an operation of charging drive energy reservoir 125 has already been completed.

From sensor 130, processing device 135 receives a signal that indicates whether a motor vehicle 120 is present in the region of parking space 105. Sensor 130 can be embodied in a variety of configurations, for example as a light barrier, ultrasonic sensor, radar sensor, lidar sensor, laser sensor, or camera. In an embodiment, sensor 130 is configured to scan several parking spaces 105 for occupancy by a respective motor vehicle 120. An optical camera whose field of view encompasses several parking spaces 105 can be provided, for example, for that purpose. In this embodiment, sensor 130 is preferably mounted at some distance from parking space 105. In other embodiments, sensor 130 can also be mounted directly in the region of parking space 105, for example in recessed or raised fashion on the parking surface of parking space 105, or above parking space 105 or above the space provided for motor vehicle 120. In another embodiment, sensor 130 is disposed in the region of charging device 110 or, particularly preferably, is integrated therewith in one shared apparatus. Charging device 110 can encompass, for example, a charging pedestal or a similar control element, from which a driver of motor vehicle 120 can create the connection between motor vehicle 120 and charging device 110 by way of connecting cable 115. In this case charging device 110 is usually mounted so that it can conveniently be operated by one person, and is therefore at a certain height above the ground. Sensor 130 can more easily detect motor vehicle 105 from such a position. Installation and connection costs for sensor 130 integrated with charging device 110 can thereby be reduced.

In yet another embodiment, sensor 130 encompasses a camera. This embodiment is suitable both for integration with charging device 110 and for separate mounting of sensor 130. The camera can furnish still or moving images of motor vehicle 120. In an embodiment, a license plate 140 on which an official identifier of motor vehicle 120 is indicated can be scanned by way of the camera. The identifier can be recognized and forwarded to processing device 135. In an embodiment, the recognition of license plate 140 is accomplished by processing device 135.

A system 145 for release control of parking space 105 is thereby indicated. Reservation system 100 usually also encompasses additional components. These can include, in particular, a further processing device 150 and an optional database 155. System 145 for release control can be embodied, however, in a manner integrated with reservation system 100; in particular, processing devices 135 and 150 can coincide. By way of interface 155, for example, a driver of a motor vehicle 120 can apply for a reservation for parking space 105. For that purpose, a check can be made as to whether parking space 105 is available for occupancy by a motor vehicle 120 having or not having a drive energy reservoir 125. The occupancy status of parking space 105 can be stored in database 155. A scan can be made for that purpose, by way of the information of sensor 130 and of charging device 110, as to whether a motor vehicle 120 is present in parking space 105 and whether motor vehicle 120 is connected to the charging device 110.

A determination can furthermore be made as to whether charging of motor vehicle 120 is currently taking place. An occupancy status of parking space 105 can accordingly encompass “vacant,” “occupied with connection,” “occupied with charging operation,” “occupied without connection,” or “occupied with connection without charging operation.” Not all the aforesaid occupancy statuses need to be distinguished from one another, however, and other occupancy statuses can also be defined. Based on the occupancy status it is then possible to check whether parking space 105 is suitable for the reservation request. A distinction can be made for that purpose, in particular, as to whether or not the reservation request also encompasses a charging request. If parking space 105 is to be released for utilization by motor vehicle 120, a parking receipt or another type of material or non-material authorization for utilization of parking space 105 can then, for example, be issued in known fashion. A non-material authorization can encompass, for example, a code that is transmitted to the user of interface 155. In an embodiment, the authorization for utilization of parking space 105 is associated with a specific motor vehicle 120, so that an identification of motor vehicle 120 is to be conveyed to reservation system 100 in the context of the reservation operation.

Motor vehicle 120 can then be moved into parking space 105 and optionally connected to charging apparatus 110 in order to carry out a charging operation.

In an embodiment, sensor 130 is configured to scan an identification of motor vehicle 120 and forward it to processing device 135. Processing device 135 can then check whether motor vehicle 120 that is, or is being, parked in parking space 105 carries an identification that is associated with an authorized motor vehicle 120. A corresponding check of a charging authorization can also be made. If the comparison is negative, i.e., if motor vehicle 120 is not authorized to park in parking space 105 and/or to be charged from charging device 110, processing device 135 can then output a corresponding warning.

That warning can be directed, for example, to processing device 150. In another embodiment the warning can also be outputted in the region of parking space 105 by way of an output device 160 that can be encompassed by system 145 for release control. The warning can be directed in particular to a driver of motor vehicle 120 and can be outputted, for example, acoustically and/or optically. Output device 160 can also be directed, for example, to service personnel for the management of parking space 105. In this case, output device 160 can also be provided at a location other than in the region of parking space 105. Alternatively or additionally, a towing service and/or law enforcement officer (police) can be informed for the purpose of removal or prosecution. In a variant, when improper occupancy of parking space 105 is recognized by way of sensor 130, an identification of motor vehicle 120 can be captured and stored, for example, by processing device 135. Storage can occur in database 155. Improper utilization can thereby be better documented. In a further variant, documentation can occur independently of any detection of improper occupancy of parking space 105.

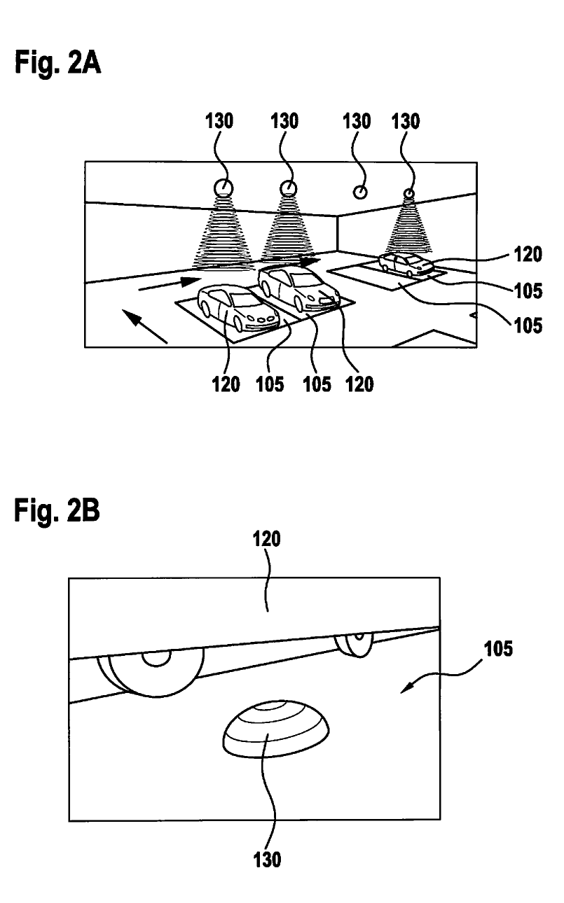

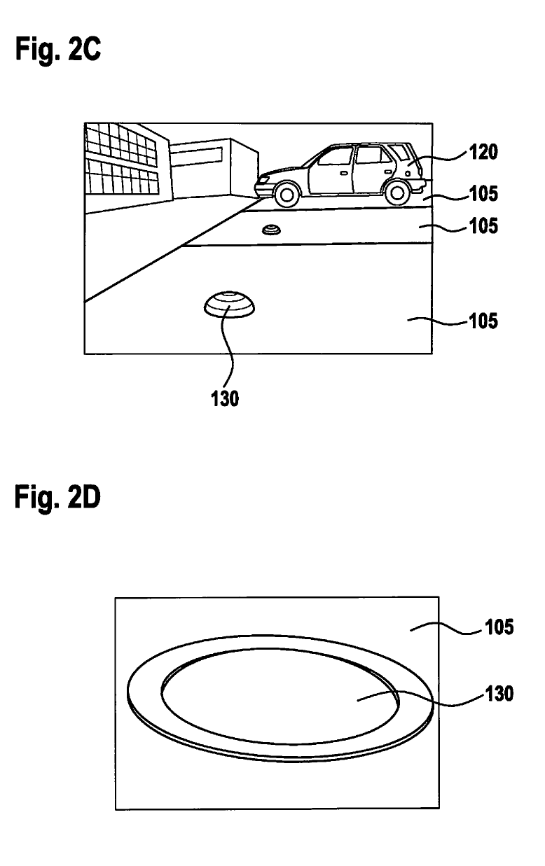

FIGS. 2A-2D show different embodiments for sensor 130 of FIG. 1. FIG. 2A shows mounting of sensor 130 above parking space 105. Several parking spaces 105 are depicted, each of which has a sensor 130 associated with it.

FIGS. 2B and 2C show mounting of sensor 130 on the ground surface of parking space 105, below a space that is provided for parking motor vehicle 120. The embodiment of sensor 130 which is depicted is raised, and preferably is such that it can also be rolled over or driven over by motor vehicle 120. Here as well, a dedicated sensor 130 is again associated with each parking space 105.

FIG. 2D shows a variant of sensor 130 shown in FIGS. 2B and 2C, sensor 130 being recessed into the ground surface. The upper side of sensor 130 is preferably flush with the parking surface of parking space 105. It is nonetheless preferably possible to drive or roll over sensor 130.

1-11. (canceled)

12. A system for release control of a parking space, the system comprising:
an electrical charging device for a motor vehicle having an electrical drive energy reservoir, wherein the electrical charging device is mounted at the parking space;
a sensor configured to detect whether the parking space is occupied by any motor vehicle;
a charge status device configured to determine whether the charging system is in operation;
a processing unit configured to release the parking space for use by a motor vehicle having an electrical drive energy reservoir conditional upon (a) the charging system being determined by the charge status device as not being connected to any motor vehicle and (b) the parking space being detected by the sensor as being unoccupied by any motor vehicle.

13. The system of claim 12, wherein the sensor and the charging device are integrated with each other into a single device.

14. The system of claim 12, wherein the sensor is not integrated with the charging device.

15. The system of claim 14, wherein the sensor is mounted at a region over the parking space.

16. The system of claim 12, wherein the sensor includes a camera, and the processing unit is configured to store a camera image or a camera video from the camera if a motor vehicle is present in the parking space.

17. The system of claim 12, wherein the processing unit is configured to forward an occupancy status of the parking space to a reservation system that is configured to book reservations of the parking space.

18. A method for release control of a parking space, the method comprising:
determining, by a processing unit and based on sensor information, that an electrical charging device arranged at the parking space is not connected to any motor vehicle and that the parking space is not occupied by any motor vehicle; and
in response to, and conditional upon, the determinations, releasing, by the processing unit, the parking space for utilization by a motor vehicle having an electrical drive energy reservoir.

19. The method of claim 18, further comprising:
scanning an identification of a motor vehicle present in the parking space;
comparing the identification with an identification of a motor vehicle for which a valid reservation for using the parking space has been issued; and
outputting a warning if the identifications do not match.

20. The method of claim 19, wherein the warning includes the identification of the motor vehicle present in the parking space.

21. The method of claim 19, wherein the warning includes a camera image of the motor vehicle present in the parking space.

22. A non-transitory computer-readable medium on which are stored instructions that are executable by a processor and that, when executed by the processor, cause the processor to perform a method for release control of a parking space, the method comprising:
determining, based on sensor information, that an electrical charging device arranged at the parking space is not connected to any motor vehicle and that the parking space is not occupied by any motor vehicle; and
in response to, and conditional upon, the determinations, releasing the parking space for utilization by a motor vehicle having an electrical drive energy reservoir.
